(19) United States
(12) Patent Application Publication
(10) Pub. No.: US 2003/0169670 A1
(43) Pub. Date: Sep. 11, 2003

(54) Optical recording medium

(75) Inventor: Hiroshi Hirayama, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA CORPORATION

(21) Appl. No.: 10/286,874

(22) Filed: Nov. 4, 2002

(30) Foreign Application Priority Data
Nov. 8, 2001 (JP) 343124/2001
Aug. 23, 2002 (JP) 243859/2002

(51) Int. Cl. G11B 7/135

(52) U.S. Cl. 369/112.23; 369/283

(57) ABSTRACT

In an optical recording medium for conducting at least one of reading and recording of optical information, the optical recording medium includes: a base board; and an antireflection layer composed of at least one layer, which is provided on a surface of a side of the base board where light enters for conducting at least one of the reading and recording of information. A wavelength of light that makes reflectance of the antireflection layer to light to be smallest is longer than that of the light that enters for conducting at least one of the reading and recording of information.

### BACKGROUND OF THE INVENTION

The present invention relates to an optical recording medium capable of conducting at least one of reading and recording of optical information.

There have been known technologies to read information from an optical recording medium such as CD (Compact Disk) or DVD (Digital Versatile Disk) and to reproduce them, or to record information optically on an optical recording medium such as CD-R (Compact Disk Recordable). In these technologies, there have been devised in many ways so that reproducing and recording of information may be conducted at high efficiency.

In an optical system of an optical information recording and reproducing device (pickup device) that conducts recording and reproducing of optical information, for example, there is known one wherein an antireflection layer is provided on an optical part such as a collimator lens, a polarization beam splitter or an objective lens. Due to this, it is possible to improve efficiency of using light and thereby to conduct recording and reproducing of optical information satisfactorily.

Further, for realizing high density optical recording, there has been made a trial for downsizing an optical spot diameter. Since the optical spot diameter is proportional to a wavelength of a laser used in an optical information recording and reproducing device and is inversely proportional to a numerical aperture (NA) of an objective lens, a laser with a shorter wavelength and an objective lens with higher NA have come to be used. There is also known a technology to provide a filter that intersects a central portion of a light flux between a laser light source and an objective lens, in an optical information recording and reproducing device, and thereby to make an optical spot diameter to be small by a super-resolution effect.

There is further known a technology wherein a filter that intersects outer ring-shaped zone portions of a light flux is inserted between a laser light source and an objective lens, and thereby, a side-lobe of a laser beam spot is reduced by an apodization effect, in an optical information recording and reproducing device. By reducing the side-lobe, erroneous operations of the optical information recording and reproducing device can be prevented, and recording and reproducing of information can be conducted accurately.

In the prior art stated above, however, efficiency of using light is not improved sufficiently on the optical recording medium side, although the efficiency of using light is improved by providing an antireflection layer on an optical system on the optical information recording and reproducing device, which is a problem. On the optical recording medium side, in particular, light loss is doubled by reciprocation of light caused by its reflection. Therefore, prevention of a decline of efficiency of using light has been sought.

Further, though an objective lens with high numerical aperture has come to be used on the optical information recording and reproducing device, there has not been indicated any guide showing how to improve, according to NA of the objective lens, the efficiency of using light properly.

There is further a restriction for shorter wavelength of a laser beam and higher NA of an objective lens. In addition, when a filter is inserted between a laser light source and an objective lens for obtaining a super-resolution effect and an apodization effect, the number of parts of the optical information recording and reproducing device was increased, and man-hour for assembly was increased, which has been a problem. Further, positioning between the filter and an optical axis needs to be highly precise, which has been time-consuming.

### SUMMARY OF THE INVENTION

With a background of the problems mentioned above, an object of the invention is to further improve efficiency to conduct reading and recording of optical information.

In particular, the object of the invention is to enhance the efficiency of using light and thereby to conduct reading and recording of optical information satisfactorily. A further object is to improve the efficiency of using light properly in accordance with NA of an objective lens of an optical information recording and reproducing device.

A further object is to downsize an optical spot diameter and thereby to realize high density recording, without making a wavelength of a laser to be shorter, without making NA of an objective lens to be higher, and without increasing the number of parts of an optical information recording and reproducing device.

A still further object is to reduce a side-lobe of an optical spot and thereby to prevent erroneous operations for reading and recording of optical information, without increasing the number of parts of an optical information recording and reproducing device.

The objects stated above can be attained by either one of the following Structures (1)-(26).

Structure (1): An optical recording medium capable of conducting at least one of reading and recording of optical information, wherein an antireflection layer composed of at least one layer is provided on the side of the optical recording medium where light enters for conducting at least one of reading and recording of information.

With respect to the “antireflection layer” in this case, when it is provided on the side of the optical recording medium where light enters for conducting at least one of reading and recording of information, the “antireflection layer” means all layers each being composed so that the reflectance of the light on the side where the light enters may be lower, compared with an occasion where the antireflection layer is not provided on the side where the light enters.

When “the antireflection layer is provided on the side of the optical recording medium where light enters for conducting at least one of reading and recording of information”, an occasion where the antireflection layer is provided inside the optical recording medium that transmits the incident light is also included, in addition to an occasion where the antireflection layer is provided on the surface (uppermost portion) of the side where the light enters.

In the Structure (1), it is possible to prevent that the incident light is reflected when conducting reading and recording of optical information, because the antireflection layer is provided on the optical recording medium, and it is possible to enhance the efficiency of using light, compared with an occasion where no antireflection layer is provided. Accordingly, it is possible to conduct reading and recording of optical information more satisfactorily, and to further improve efficiency of reading and recording of information.

Structure (2): The optical recording medium according to the Structure (1), wherein the aforementioned antireflection layer is provided on the uppermost portion on the surface of the side where light enters for conducting at least one of reading and recording of information.

In the Structure (2), it is possible to prevent surely that light is reflected on the surface of the optical recording medium, when conducting reading or recording of information, because the antireflection layer is provided on the surface of the optical recording medium.

Structure (3): The optical recording medium according to the Structure (1) or the Structure (2), wherein a wavelength of the light that makes the aforementioned reflectance of the antireflection layer to light to be smallest is longer than that of the light that enters for conducting at least one of reading and recording of information.

In the Structure (3), it is possible to prevent effectively that light which enters for conducting reading or recording of information is reflected, because there is used an antireflection layer that shows the minimum value of reflectance for light having a wavelength that is longer than that of light entering for conducting reading or recording of information.

Structure (4): The optical recording medium according to either one of the Structures (1)-(3), wherein at least one of reading and recording of information can be conducted by light that is converged by an objective lens with a numerical aperture smaller than 0.60, and the following condition is satisfied;

1.00 λ₀≦λ<1.03 λ₀

(wherein, λ₀ represents a wavelength of light that enters for conducting at least one of reading and recording of information, and λ represents a wavelength of light that makes the reflectance of the antireflection layer to be minimum.)

In this case, the numerical aperture of the objective lens is an image side numerical aperture which is eventually the numerical aperture on the optical recording medium side.

In the Structure (4), it is possible to prevent effectively that the incident light is reflected, and thereby to improve the efficiency of using light, when conducting reading or recording of information with light converged by the objective lens whose numerical aperture is smaller than 0.60, because the antireflection layer satisfies the conditions stated above.

Structure (5): The optical recording medium according to either one of the Structures (1)-(3), wherein at least one of reading and recording of information can be conducted by light that is converged by an objective lens whose numerical aperture is not less than 0.60 and is smaller than 0.80, and the following condition is satisfied;

1.03 λ₀≦λ<1.05 λ₀

(wherein, λ₀ represents a wavelength of light that enters for conducting at least one of reading and recording of information, and λ represents a wavelength of light that makes the reflectance of the antireflection layer to be minimum.)

In the Structure (5), it is possible to prevent effectively that the incident light is reflected, and thereby to improve the efficiency of using light, when conducting reading or recording of information with light converged by the objective lens whose numerical aperture is not less than 0.60 and is smaller than 0.80, because the antireflection layer satisfies the conditions stated above.

Structure (6): The optical recording medium according to either one of the Structures (1)-(3), wherein at least one of reading and recording of information can be conducted by light that is converged by an objective lens whose numerical aperture is not less than 0.80, and the following condition is satisfied;

1.05 λ₀≦λ<1.50 λ₀

(wherein, λ₀ represents a wavelength of light that enters for conducting at least one of reading and recording of information, and λ represents a wavelength of light that makes the reflectance of the antireflection layer to be minimum.)

In the Structure (6), it is possible to prevent effectively that the incident light is reflected, and thereby to improve the efficiency of using light, when conducting reading or recording of information with light converged by the objective lens whose numerical aperture is not less than 0.80, because the antireflection layer satisfies the conditions stated above.

Structure (7): The optical recording medium according to either one of the Structures (1)-(6), wherein at least one of reading and recording of information can be conducted by light that is converged by an objective lens, and the maximum value of transmittance of the aforementioned antireflection layer for the light that enters after passing a space between the center of the objective lens and the outermost circumference within an effective diameter of the objective lens is greater than transmittance of the antireflection layer for the light that enters after passing the center of the objective lens and is greater than transmittance of the antireflection layer for the light that enters after passing the outermost circumference of the objective lens.

In the Structure (7), the rate of transmittance through the antireflection layer for the light that enters after passing through a space between the center of the objective lens and the outermost circumference is greater, compared with that for the light that enters after passing through the center of the objective lens and with that for the light that enters after passing through the outermost circumference of the objective lens. Namely, an amount of light that is transmitted through the antireflection layer after passing through a space between the center and the outermost circumference of the objective lens is relatively more. Therefore, it is possible to make the total amount of transmittance of light through the antireflection layer to be great, by making the light passing through a space between the center and the outermost circumference of the objective lens to enter the antireflection layer, namely, to enhance the efficiency of using light.

Structure (8): The optical recording medium according to either one of the Structures (1)-(7), wherein a transparent base board is provided between the antireflection layer and an information recording surface which is provided to be closer to the rear surface side than the antireflection layer and is to be recorded with information or has been recorded with information, and the total amount of plural rays of light entering the antireflection layer at various incident angles, then, passing through the antireflection layer and the transparent base board, and entering the information recording surface is greater than the total amount of plural rays of light which enter the transparent base board at various incident angles when the antireflection layer is not provided and pass through the transparent base board to enter the information recording surface.

In the Structure (8), the total amount of plural rays of light entering the antireflection layer at various incident angles, then, passing through the antireflection layer and the transparent base board, and entering the information recording surface is greater than the total amount of plural rays of light which enter the transparent base board at various incident angles when the antireflection layer is not provided and pass through the transparent base board to enter the information recording surface. Compared with an occasion wherein no antireflection layer is provided, therefore, it is possible to make the total amount of light entering the information recording surface to be greater, and eventually, to enhance the efficiency of using light.

Structure (9): The optical recording medium according to either one of the Structures (1)-(8), wherein a transparent base board is provided between the antireflection layer and an information recording surface which is provided to be closer to the rear surface side than the antireflection layer and is to be recorded with information or has been recorded with information, and transmittance for light entering the antireflection layer at the maximum incident angle, then, passing through the antireflection layer and the transparent base board, and entering the information recording surface is greater than that of light which enters the transparent base board at the maximum incident angle when the antireflection layer is not provided and passes through the transparent base board to enter the information recording surface.

In the Structure (9), the transmittance for light entering the antireflection layer at the maximum incident angle, then, passing through the antireflection layer and the transparent base board, and entering the information recording surface is greater than that for light which enters the transparent base board at the maximum incident angle when the antireflection layer is not provided and pass through the transparent base board to enter the information recording surface. Namely, compared with an occasion wherein no antireflection layer is provided, therefore, an amount of light entering the information recording surface at the maximum incident angle is large. Therefore, it is possible to make an amount of light entering the information recording surface of the optical recording medium to be large, by making light including a ray of light having the maximum incident angle to enter the antireflection layer, and eventually, to enhance the efficiency of using light.

Structure (10): An optical recording medium capable of conducting at least one of reading and recording of information by means of light, wherein there is provided, on the side where light enters for conducting at least one of reading and recording of information, an optical layer that is composed of at least one layer and has smaller transmittance for light when an incident angle is smaller within a range of the prescribed incident angle for light. The “prescribed incident angle” represents the maximum incident angle of light entering the optical recording medium, for example, for conducting recording or reading of information.

In the Structure (10), the optical recording medium is provided with the optical layer whose transmittance is smaller when the incident angle of light is smaller, and therefore, the light having the smaller incident angle is more hardly transmitted through the optical layer. Due to this, an amount of light entering at a small incident angle can be reduced, and an optical spot diameter can be made small by a super-resolution effect, in the same way as in the conventional occasion wherein the center of a light flux is shielded by a filter.

Therefore, it is possible to realize high density recording and to improve efficiency of reading or recording of information by means of light without making a wavelength of a laser to be shorter, without making NA of an objective lens to be higher, and without increasing the number of parts of an optical information recording and reproducing device.

Structure (11): An optical recording medium capable of conducting at least one of reading and recording of information by means of light, wherein there is provided, on the side where light enters for conducting at least one of reading and recording of information, an optical layer that is composed of at least one layer and has smaller transmittance for light when an incident angle is greater within a range of the prescribed incident angle for light. The “prescribed incident angle” represents the maximum incident angle of light entering the optical recording medium, for example, for conducting recording or reading of information.

In the Structure (11), the optical recording medium is provided with the optical layer whose transmittance is smaller when the incident angle of light is greater, and therefore, the light having the greater incident angle is more hardly transmitted through the optical layer. Due to this, an amount of light entering at a large angle can be reduced, and a side-lobe of a light spot is reduced by an apodization effect in the same way as in the conventional occasion wherein an outer ring-shaped zone portion of a light flux is shielded by a filter.

It is therefore possible to improve efficiency of reading and recording of information by preventing erroneous operations for reading and recording of information by means of light, without increasing the number of parts of an optical information recording and reproducing device.

Structure (12): An optical recording medium capable of conducting at least one of reading and recording of information by means of light, wherein there is provided, on the side where light enters for conducting at least one of reading and recording of information, an optical layer that is composed of at least one layer and has different transmittances on both sides of a boundary of a prescribed wavelength.

In this case, when the optical layer has “different transmittances on both sides of a boundary of a prescribed wavelength”, there are included an occasion where “transmittance for light on the front wavelength area of the prescribed wavelength, namely, the wavelength area closer to the short wavelength side than the prescribed wavelength is smaller than that on the rear wavelength area”, namely, the wavelength area closer to the long wavelength side than the prescribed wavelength is smaller than that on the rear wavelength area”, and an occasion where “transmittance for light on the rear wavelength area of the prescribed wavelength area is smaller than that on the front wavelength area”.

In the Structure (12), in the case of the aforesaid occasion that “the transmittance of the front wavelength area for light is smaller than that of the rear wavelength area for light”, it is difficult for the light entering at a small incident angle to be transmitted through the optical layer. In the same way as in the invention described in Structure (10), therefore, it is possible to realize high density recording by downsizing an optical spot diameter, and to improve efficiency to read and record optical information.

Further, in the case of the aforesaid occasion that “the transmittance of the rear wavelength area for light is smaller than that of the front wavelength area for light”, it is difficult for the light entering at a large incident angle to be transmitted through the optical layer. In the same way as in the invention described in Structure (11), therefore, it is possible to prevent erroneous operations for reading and recording of information by reducing a side-lobe of an optical spot, and to improve efficiency to read and record optical information.

Structure (13): The optical recording medium according to either one of the Structures (10)-(12), wherein the optical layer is provided on the surface of the side where light enters for conducting at least one of reading and recording of information.

In the Structure (13), an amount of incident light transmitted through the optical layer can be controlled surely on the surface of the optical recording medium, when conducting reading or recording of information, because the optical layer is provided on the surface of the side where the light enters.

Structure (14): A method of recording and reading of information that conducts at least one of recording of information for an optical recording medium and reading of recorded information both by converging light with an objective lens, wherein light passes through an antireflection layer that is composed of at least one layer and is provided on the optical recording medium to conduct at least one of recording and reading of information.

The “antireflection layer”, in this case, means all layers which are structured so that reflectance for the light on the side where the light enters may be lower, compared with an occasion where no antireflection layer is provided, when the antireflection layer is provided on the side where the light enters, for conducting at least one of reading and recording of information on the optical recording medium. This antireflection layer may either be provided on the surface on the side where the light enters, or be provided inside the optical recording medium through which the incident light passes.

In the Structure (14), it is possible to prevent, by making the light to pass through the antireflection layer, that the light entering an optical recording medium is reflected, and thereby to enhance the efficiency to use light, compared with an occasion where no antireflection layer is provided. It is therefore possible to conduct recording and reading of information by means of light more, more satisfactorily, and thereby to improve more the power of recording and reading of information.

Structure (15): The method of recording and reading information according to Structure (14), wherein the light converged by the objective lens is made to pass the antireflection layer first in the optical recording medium.

In the invention described in Structure (15), it is possible to prevent surely that the light is reflected on the surface of the optical recording medium, by making the light converged by the objective lens to pass through the antireflection layer first in the optical recording medium.

Structure (16): The method of recording and reading information according to Structure (14) or Structure (15), wherein at least one of recording and reading of information is conducted by the light having the wavelength that is shorter than the wavelength of light which makes reflectance of the antireflection layer for light to be minimum.

In the invention described in Structure (16), even when recording or reading of information is conducted by the light having the wavelength that is shorter than the wavelength of light which makes reflectance of the antireflection layer for light to be minimum, it is still possible to prevent effectively that incident light is reflected, and thereby to enhance the efficiency of using light, because the light stated above passes through the antireflection layer.

Structure (17): The method of recording and reading information according to either one of Structures (14)-(16), wherein the numerical aperture of the objective lens is smaller than 0.60, and at least one of recording and reading of information is conducted by means of light satisfying the following condition;

0.97λ<λ0≦1.00λ

(wherein, λ0 represents a wavelength of light that enters for conducting at least one of recording and reading of information, and λ represents a wavelength of light that makes reflectance of the antireflection layer to be minimum.)

In this case, the numerical aperture of the objective lens is an image side numerical aperture which is eventually the numerical aperture on the optical recording medium side.

In the Structure (17), it is possible to prevent effectively that incident light is reflected, and thereby to enhance the efficiency of using light, by conducting recording or reading of information by means of light satisfying the condition mentioned above, because an objective lens whose numerical aperture is smaller than 0.60 is used.

Structure (18): The method of recording and reading information according to either one of Structures (14)-(16), wherein the numerical aperture of the objective lens is not less than 0.60 and is smaller than 0.8, and at least one of recording and reading of information is conducted by means of light satisfying the following condition;

0.95 λ<λ0≦0.97 λ

(wherein, λ0 represents a wavelength of light that enters for conducting at least one of recording and reading of information, and λ represents a wavelength of light that makes reflectance of the antireflection layer to be minimum.)

In this case, the numerical aperture of the objective lens is an image side numerical aperture which is eventually the numerical aperture on the optical recording medium side.

In the invention described in Structure (18), it is possible to prevent effectively that incident light is reflected, and thereby to enhance the efficiency of using light, by conducting recording or reading of information by means of light satisfying the condition mentioned above, because an objective lens whose numerical aperture is not less than 0.60 and is smaller than 0.80 is used.

Structure (19): The method of recording and reading information according to either one of Structures (14)-(16), wherein the numerical aperture of the objective lens is not less than 0.80, and at least one of recording and reading of information is conducted by means of light satisfying the following condition;

0.67 λ<λ0≦0.95 λ

(wherein, λ0 represents a wavelength of light that enters for conducting at least one of recording and reading of information, and λ represents a wavelength of light that makes reflectance of the antireflection layer to be minimum.)

In this case, the numerical aperture of the objective lens is an image side numerical aperture which is eventually the numerical aperture on the optical recording medium side.

In the invention described in Structure (19), it is possible to prevent effectively that incident light is reflected, and thereby to enhance the efficiency of using light, by conducting recording or reading of information by means of light satisfying the condition mentioned above, because an objective lens whose numerical aperture is not less than 0.80 is used.

Structure (20): The method of recording and reading information according to either one of Structures (14)-(19), wherein the maximum value of transmittance of the antireflection layer for light entering after passing through a space between the center of the objective lens and the outermost circumference within an effective diameter of the objective lens is greater than that of transmittance of the antireflection layer for light entering after passing through the center of the objective lens, and is greater than that of transmittance of the antireflection layer for light entering after passing through the outermost circumference of the objective lens.

In the Structure (20), the maximum value of transmittance for light entering after passing through a space between the center of the objective lens and the outermost circumference within an effective diameter of the objective lens is greater than that of transmittance for light entering after passing through the center of the objective lens, and is greater than that of transmittance for light entering after passing through the outermost circumference of the objective lens, due to the antireflection layer, and therefore, it is possible to make a relatively large quantity of light entering after passing through a space between the center of the objective lens and the outermost circumference to pass through the antireflection layer, by making the light to pass through the antireflection layer to conduct recording or reading of information. Therefore, the total amount of light passing through the antireflection layer can be made large when conducting recording or reading of information, namely, the efficiency of using light can be enhanced.

Structure (21): The method of recording and reading information according to either one of Structures (14)-(20), wherein a transparent base board is provided on the optical recording medium between the antireflection layer and the information recording surface that is provided to be closer to the rear side than the antireflection layer and is recorded or has been recorded with information, and the total amount of plural rays of light entering the antireflection layer at various incident angles, then, passing through the antireflection layer and the transparent base board, and entering the information recording surface is greater than the total amount of plural rays of light which enter the transparent base board at various incident angles when the antireflection layer is not provided and pass through the transparent base board to enter the information recording surface, thus, at least one of recording and reading of information is conducted by making plural rays of light enter the antireflection layer at various incident angles.

In the Structure (21), the total amount of plural rays of light entering the antireflection layer at various incident angles, then, passing through the antireflection layer and the transparent base board, and entering the information recording surface is greater than the total amount of plural rays of light which enter the transparent base board at various incident angles when the antireflection layer is not provided and pass through the transparent base board to enter the information recording surface. It is therefore possible to make an amount of light entering the information recording surface to be large, by making plural rays of light to enter the antireflection layer at various incident angles to conduct recording or reading of information, compared with an occasion where no antireflection layer is provided. Namely, the efficiency of using light can be enhanced.

Structure (22): The method of recording and reading information according to either one of Structures (14)-(21), wherein a transparent base board is provided on the optical recording medium between the antireflection layer and the information recording surface that is provided to be closer to the rear side than the antireflection layer and is recorded or has been recorded with information, and transmittance for the light that enters the antireflection layer at the maximum incident angle and passes through the antireflection layer and the transparent base board to enter the information recording surface is greater than transmittance for the light that enters the transparent base board at the maximum incident angle when the antireflection layer is not provided and passes through the transparent base board to enter the information recording surface, thus, a plurality of rays of light including light having the maximum incident angle are made to enter the antireflection layer, and at least one of recording and reading of information is conducted.

In the Structure (22), transmittance for the light that enters the antireflection layer at the maximum incident angle and passes through the antireflection layer and the transparent base board to enter the information recording surface is greater than transmittance for the light that enters the transparent base board at the maximum incident angle when the antireflection layer is not provided and passes through the transparent base board to enter the information recording surface. It is therefore possible to make an amount of light entering the information recording surface to be large, compared with an occasion where no antireflection layer is provided, by making plural rays of light including light having the maximum incident angle to enter the antireflection layer to conduct recording or reading of information. Namely, the efficiency of using light can be enhanced.

Structure (23): A method of recording and reading information for conducting at least one of recording and reading of information for an optical recording medium by converging light with an objective lens, wherein light is made to pass through an optical layer that is composed of at least one or more layers so that transmittance for the light may be smaller when an incident angle for the light is smaller within a range of the prescribed incident angle, to conduct at least one of recording and reading of information.

“Prescribed incident angle” in this case is a maximum incident angle for light entering an optical recording medium for conducting, for example, recording and reading of information.

In the Structure (23), since the transmittance for light is made to be smaller when an incident angle for light is smaller within a range of the prescribed incident angle, it is possible to reduce an amount of light entering at a small incident angle, and thereby to make an optical spot diameter small by a super-resolution effect, in the same way as in the past where the center of a light flux is shielded by a filter.

It is therefore possible to realize high density recording, and to improve more the power of recording and reading of information by means of light, by realizing neither short wavelength of a laser nor high NA of an objective lens, and without increasing the number of parts of an optical information recording and reproducing apparatus.

Structure (24): A method of recording and reading information for conducting at least one of recording and reading of information for an optical recording medium by converging light with an objective lens, wherein light is made to pass through an optical layer that is composed of at least one or more layers so that transmittance for the light may be smaller when an incident angle for the light is greater within a range of the prescribed incident angle, to conduct at least one of recording and reading of information.

“Prescribed incident angle” in this case is a maximum incident angle for light entering an optical recording medium for conducting, for example, recording and reading of information.

In the Structure (24), since the transmittance for the light is made to be smaller by the optical layer when an incident angle for the light is greater within a range of the prescribed incident angle, it is possible to reduce an amount of light entering at a large incident angle, and thereby to reduce a side-lobe of an optical spot by apodization effect, by making light to pass through the optical layer and by conducting recording or reading of information, in the same way as in the past where the outer ring-shaped portion of a light flux is shielded by a filter.

It is therefore possible to prevent erroneous operations in recording and reading of information by means of light, and thereby to improve more the power of recording and reading information, without increasing the number of parts of an optical information recording and reproducing apparatus.

Structure (25): A method of recording and reading information for conducting at least one of recording and reading of information for an optical recording medium by converging light with an objective lens, wherein at least one of recording and reading of information is conducted by making light to pass through an optical layer that is composed of at least one or more layers so that transmittances for the light may be different each other on both sides of a boundary of the prescribed wavelength, and is provided on the optical recording medium.

In this case, when “transmittances for the light are different each other on both sides of a boundary of the prescribed wavelength, there are included an occasion wherein “transmittance for light in the wavelength area where the wavelength precedes the prescribed wavelength, namely, the wavelength area where the wavelength is shorter than the prescribed wavelength is smaller than that in the wavelength area where the wavelength succeeds the prescribed wavelength, namely, the wavelength area where the wavelength is longer than the prescribed wavelength”, and an occasion wherein “transmittance for light in the wavelength area where the wavelength succeeds the prescribed wavelength is smaller than that in the wavelength area where the wavelength precedes the prescribed wavelength”.

In the invention described in Structure (25), when “transmittance for light in the wavelength area preceding the prescribed wavelength is smaller than that in the wavelength area succeeding the prescribed wavelength”, it becomes difficult for light entering at a small incident angle to pass through the optical layer, when the light is made to pass through the optical layer for conducting recording or reading of information. Therefore, in the same way as in the invention described in Structure 23, it is possible to realize high density recording by making an optical spot diameter small, and to improve the power to record and read information by means of light.

Further, when “transmittance for light in the wavelength area succeeding the prescribed wavelength is smaller than that in the wavelength area preceding the prescribed wavelength”, it becomes difficult for light entering at a large incident angle to pass through the optical layer, when the light is made to pass through the optical layer for conducting recording or reading of information. Therefore, in the same way as in the invention described in Structure 24, it is possible to prevent erroneous operations for recording and reading of information by reducing a side-lobe of an optical spot, and to improve efficiency to read and record optical information.

Structure (26): The method of recording and reading information according to either one of Structures (23)-(25), wherein the light converged by the objective lens is made to pass through the optical layer first in the optical recording medium.

In the invention described in Structure (26), it is possible to conduct surely, on the surface of the optical recording medium, the control of an amount of incident light by the optical layer, by causing the light that is converged by the objective lens to pass through the optical layer first in the optical recording medium.

### BRIEF DESCRIPTION OF THE DRAWINGS

FIG. 1 is a longitudinal section showing the structure of an optical recording medium of the invention.

FIG. 2 is a schematic diagram showing an optical system of an optical information recording and reproducing device.

FIG. 3 is a graph showing wavelength-dependence of reflectance of an optical recording medium for each of Inventive Sample 1 and Comparative Sample 1.

FIG. 4 is a schematic enlarged diagram for primary portions showing an optical system to detect a base line for an amount of returned light with the optical information recording and reproducing device shown in FIG. 2.

FIG. 5 is a schematic enlarged diagram for primary portions showing an optical system to detect an amount of returned light for the optical recording medium in Comparative Sample 1 with the optical information recording and reproducing device shown in FIG. 2.

FIG. 6 is a schematic enlarged diagram for primary portions showing an optical system to detect an amount of returned light for the optical recording medium in Inventive Sample 1 with the optical information recording and reproducing device shown in FIG. 2.

FIG. 7 is a graph showing wavelength-dependence of reflectance of an optical recording medium for each of Inventive Samples 21-28.

FIG. 8 is a graph showing incident angle-dependence of reflectance of an optical recording medium for each of Inventive Samples 31-33 and Comparative Sample 1.

FIG. 9 is a graph showing incident angle-dependence of reflectance of an optical recording medium for each of Inventive Samples 41 and 42 and Comparative Sample 1.

### DETAILED DESCRIPTION OF THE PREFERRED EMBODIMENT

Embodiments of the invention will be explained as follows, referring to the drawings.

(Embodiment 1)

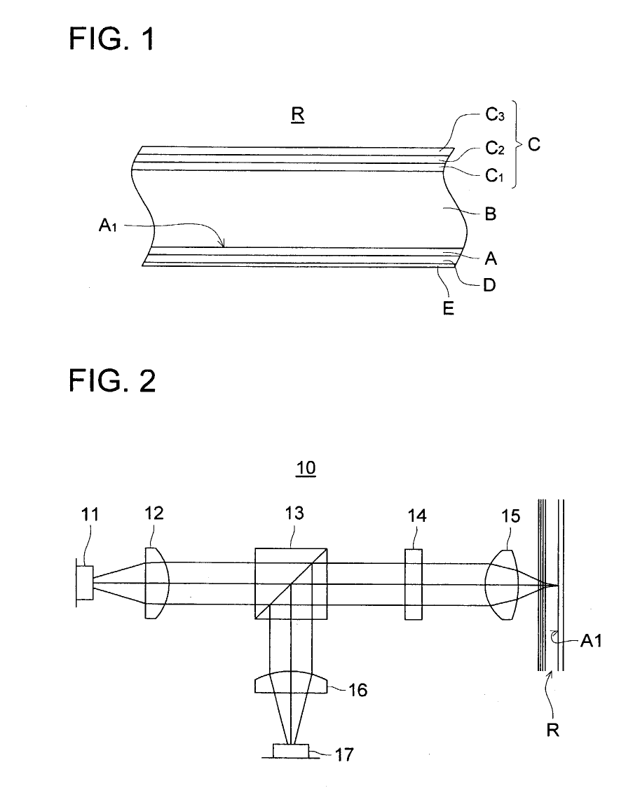

Optical recording medium R in Embodiment 1 of the invention can conduct at least one of reading and recording of information by means of light, and is composed of coating layer C, base body (transparent base board) B, information recording layer A, protective layer D that protects the information recording layer A, and printing layer E that is provided on the outer surface of the protective layer D which are laminated in this order, as shown in FIG. 1.

The information recording layer A is made, for Comparative Sample, of metal such as aluminum. Surface A1 of the information recording layer A on its side where it is adjacent to the base body B is an information recording surface which is arranged so that information may be recorded by forming the known pit land structure on the information recording surface A1. The base body B is made, for Comparative Sample, of plastic materials such as polycarbonate or acryl or of glass.

Incidentally, it is also possible to provide a dye layer on the top face of the information recording surface A1 in the same way as in the known CD-R, for Comparative Sample, which is not illustrated in FIG. 1.

The coating layer C is composed, for Comparative Sample, of the first-third coating layers C₁-C₃. Incidentally, the coating layer C may also be composed of one layer or of two or more layers, without being limited to the Comparative Sample shown in FIG. 1. The coating layer C is provided on the uppermost portion on the surface of the side (top face side in FIG. 1) where light enters for recording information on the information recording surface A1 or reading information recorded on the information recording surface A1.

Though the coating layer C is coated by, for Comparative Sample, a vacuum deposition method, it may also be coated by other methods such as a sputtering method and a vapor phase epitaxy (Chemical Vapor Deposition) method, without being limited to the vacuum deposition method.

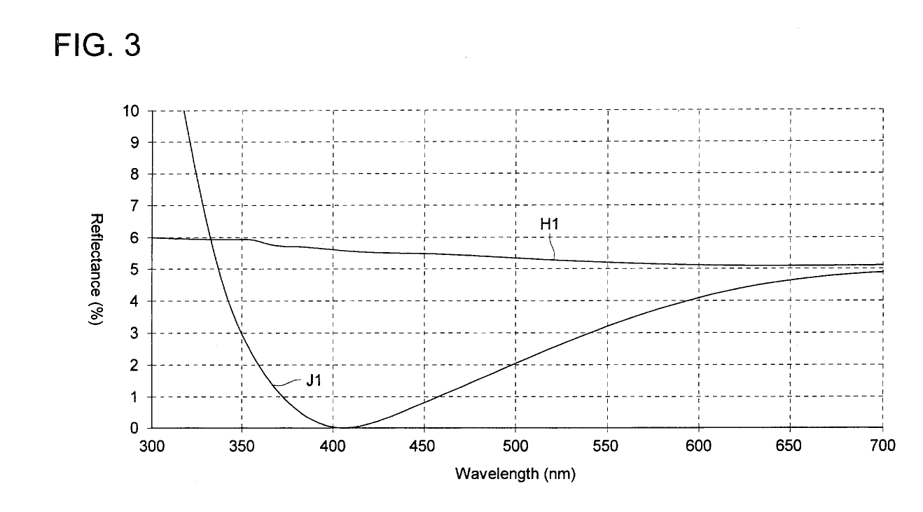

Recording of information on the information recording surface A1 of the optical recording medium R, and reading or reproducing of information recorded on the information recording surface A1 can be conducted by optical information recording and reproducing device 10 having the structure shown in FIG. 2. The optical information recording and reproducing device 10 is composed of laser diode 11, collimator lens 12, polarization beam splitter 13, quarter-wave plate 14, objective lens 15, convex lens 16 and photo-detector 17.

A laser beam emitted from the laser diode 11 is converted into a collimated light by the collimator lens 12, and then, P-component light of the collimated light only is transmitted by the polarization beam splitter 13, to be converted into a linearly polarization (P-polarized light).

The P-polarized light is converted by quarter-wave plate 14 into a right-handed circularly polarized light and passes through the objective lens 15 to be converged on the information recording surface A1 of the optical recording medium R at various incident angles, to enter. The circularly polarized light reflected on the information recording surface A1 of the optical recording medium R is converted into a circularly polarized light whose rotation is in the opposite direction (left-handed), and it passes through the objective lens 15 again to be converted into a linearly polarization with S-component only (S-polarized light) by quarter-wave plate 14.

The S-polarized light is reflected totally by polarization beam splitter 13, and is converged by convex lens 16 on photo detector 17.

In the optical information recording and reproducing device 10, it is possible to read information recorded on the information recording surface A1 of the optical recording medium R and thereby to reproduce information by detecting an amount of returned light by the photo detector 17. Further, in the structure wherein a dye layer is provided on a top surface of the information recording surface A1 of the optical recording medium R, it is possible to record information on the information recording surface A by converging a laser beam having high energy with objective lens 15.

In the optical recording medium R in the first embodiment shown in FIG. 1, coating layer C is provided on the top face side of the optical recording medium R, and thereby, thickness and materials of the first-third coating layers C₁-C₃ which constitute coating layer C are established so that reflectance of the top face side of the optical recording medium R may be lower, compared with an occasion wherein no coating layer C is provided. Namely, the coating layer C is an antireflection layer of the invention.

Owing to this coating layer C, it is possible to prevent that light is reflected on the top face side of the optical recording medium R when reading or recording of information is conducted by the optical information recording and reproducing device 10, and thereby to enhance efficiency of using light. Due to this, reading or recording of information by means of light can be conducted more satisfactorily.

Since coating layer C is provided on the uppermost surface of the optical recording medium R as shown in FIG. 1, it is possible to prevent surely that light is reflected on the uppermost portion (surface of the optical recording medium R on the left side in FIG. 2) of the surface on the side where light enters when reading or recording of information is conducted by the optical information recording and reproducing device 10.

In the aforementioned coating layer C, it is preferable that thickness and materials of the first-third coating layers C₁-C₃ are established so that a wavelength of light that makes reflectance for light to be minimum may be longer than that of a laser beam emitted from laser diode 11 of the optical information recording and reproducing device 10. With this structure, reflection of light on the surface of optical recording medium R can be prevented efficiently.

It is further preferable that the coating layer C and a laser beam emitted from laser diode 11 satisfy the following conditions;

1.00 λ₀≦λ<1.03 λ₀ (namely, 0.97 λ<λ0≦1.00 λ) for objective lens 15 with NA<0.60,

1.03 λ₀≦λ<1.05 λ₀ (namely, 0.95 λ<λ0≦0.97 λ) for objective lens 15 with 0.60≦NA<0.80, and

1.05 λ₀≦λ<1.50 λ₀ (namely, 0.67 λ<λ0≦0.95 λ) for objective lens 15 with 0.80≦NA,

wherein NA represents a numerical aperture of objective lens 15 used in optical information recording and reproducing device 10, λ₀ represents a wavelength of a laser beam emitted from laser diode 11 used in optical information recording and reproducing device 10 and λ represents a wavelength of light that makes the reflectance of coating layer C to be minimum.

Owing to this structure, it is possible to prevent effectively, in accordance with a numerical aperture of objective lens 15 in optical information recording and reproducing device 10, that light is reflected on the surface of optical recording medium R, and thereby to improve efficiency of using light properly.

In the coating layer C, it is preferable that the coating layer is structured so that the greatest value of transmittance for the light that enters after passing through a space between the center of objective lens 15 and the outermost circumference within an effective diameter of objective lens 15 is higher than that for light that enters after passing through the center of objective lens 15, and that for light that enters after passing through the outermost circumference of objective lens 15.

In this structure, the total amount of light transmitted through coating layer C can be made to be large, because an amount of light that enters after passing through a space between the center of objective lens 15 and the outermost circumference and is transmitted through coating layer C is relatively large. Therefore, efficiency of using light can be enhanced efficiently.

With respect to the coating layer C, it is preferable that the total amount of light entering information recording surface A1, namely, the total amount of plural rays of light which enter the coating layer C at various incident angles, then pass through the coating layer C and base body B, and enter the information recording surface A1 grows greater. Namely, it is preferable that an amount of light entering information recording surface A1 of optical recording medium R becomes greater, compared with an occasion where no coating layer C is provided. Due to this structure, the total amount of light entering the information recording surface can be made large, namely, efficiency of using light can be enhanced, compared with an occasion wherein no coating layer C is provided.

Incidentally, in the optical recording medium R in the first embodiment, coating layer C is provided on the surface on the plane of incidence for light. However, it is also possible to provide, for Comparative Sample, a thin layer (protective layer) having no optical influence on a top surface of coating layer C, without being limited to the aforementioned structure. Though the structure of the optical recording medium R is explained above, referring to FIG. 1, the invention is not limited to the structure shown in FIG. 1, and the structure wherein at least one of reading and recording of optical information can be conducted is satisfactory.

Optical information recording and reproducing device 10 is given as a device for reading information from the optical recording medium R or recording. However, even when reading information from the optical recording medium R or recording information on the optical recording medium R by the device or optical system having another structure, without being limited to the Comparative Sample shown in FIG. 2, it is possible to improve further the capacity to read or record optical information, by the optical recording medium R in the first embodiment.

### EXAMPLE 1

The optical recording medium (corresponding to optical recording medium R in the first embodiment) of Inventive Sample 1 having the structure shown in Table 1 below and the optical recording medium of Comparative Sample 1 having the structure shown in Table 2 below were prepared.

TABLE 1

| | | Refractive | |
|---|---|---|---|
| | Name of | index | |
| | material | (λ = 405 nm) | Thickness |
| Medium | Air | 1 | — |
| Third layer | Silicon oxide | 1.47 | 87.6 nm |
| Second layer | Tantalum | 2.12 | 20.4 nm |
| | pentoxide | | |
| First layer | Silicon oxide | 1.47 | 16.5 nm |
| Base body | Polycarbonate | 1.61 | 1.2 mm |
| Metal mirror | Aluminum | — | 500 nm |

TABLE 2

| | | Refractive | |
|---|---|---|---|
| | Name of | index | |
| | material | (λ = 405 nm) | Thickness |
| Medium | Air | 1 | — |
| Base body | Polycarbonate | 1.61 | 1.2 mm |
| Metal mirror | Aluminum | — | 500 nm |

In Table 1 and Table 2, “First layer”-“Third layer” shown in the column of medium correspond to the first-third coating layers C₁-C₃ shown in FIG. 1, “Base body” corresponds to base body B, and “Metal mirror” corresponds to information recording layer A. In the optical recording medium of Inventive Sample 1 and Comparative Sample 1, a polycarbonate plate having thickness 1.2 mm was used (this applies also to Inventive Samples 2-4 described later).

In preparation of an optical recording medium in Comparative Sample 1, an aluminum metal mirror was coated on one side of the base body through a vacuum deposition method. In the vacuum deposition, the pressure in the vacuum tank was lowered to the prescribed pressure, and a material was heated and evaporated while introducing oxygen gas, so that aluminum was deposited on the base body.

In preparation of an optical recording medium in Inventive Sample 1, an aluminum metal mirror was coated on one side of the base body through a vacuum deposition method, in the same way as in Comparative Sample 1, and coating layers (first layer-third layer) were coated on the other side of the base body through a vacuum deposition method. In the deposition of coating layers, a temperature to heat the base body was made to be 80° C., and there were used the pressure of oxygen gas of 1.0×10⁻² Pa for deposition of silicon oxide, that of 1.5×10⁻² Pa for deposition of tantalum oxide, deposition speed of 2.0 nm/sec for silicon oxide and that of 0.5 nm/sec for tantalum oxide.

FIG. 3 shows respectively a reflectance (J1) on the surface of the coating layer of the optical recording medium in Inventive Sample 1 and a reflectance (H1) on the surface on the base body side of the optical recording medium in Comparative Sample 1. Incidentally, in FIG. 3, wavelength-dependence of reflectance at an incident angle of 0° for light is shown.

(Measurement of Efficiency of Using Light)

Next, efficiency of using light for the optical recording medium in Inventive Sample 1 and that in Comparative Sample 1 were measured in the following procedures by the use of the optical system of optical information recording and reproducing device 10 shown in FIG. 2. For the measurement of efficiency of using light, laser diode 11 having an oscillation wavelength of 405 nm was used.

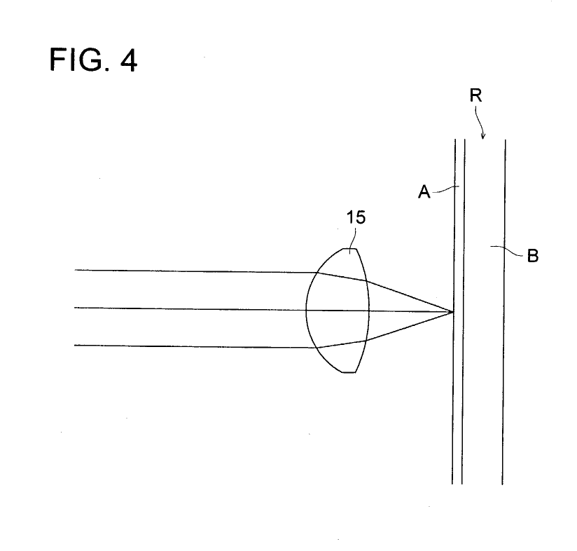

First, objective lens 15 was made to be in focus on the surface of a metal mirror (information recording layer A) without passing through base body B, as shown in FIG. 4, and then, an amount of returned light was detected by photo detector 17, and the amount of returned light thus detected was set as base line b.

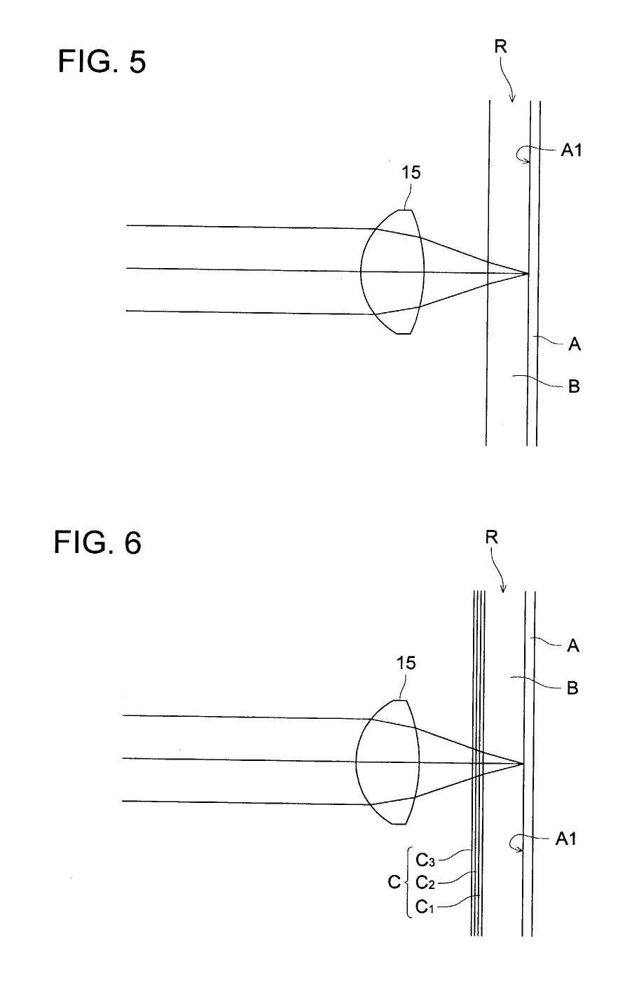

Next, objective lens 15 was made to be in focus on information recording surface A1 of metal mirror (A) through base body B by using the optical recording medium R of Comparative Sample 1, as shown in FIG. 5, and an amount of returned light was detected. A value obtained by dividing the amount of returned light thus detected with the base line B was made to be the efficiency of using light of optical recording medium R in Comparative Sample 1.

Further, objective lens 15 was made to be in focus on information recording surface A1 of metal mirror (A) through coating layer C and base body B by using the optical recording medium R of Inventive Sample 1,, as shown in FIG. 6, and an amount of returned light was detected. A value obtained by dividing the amount of returned light thus detected with the base line b was made to be the efficiency of using light of optical recording medium R in Inventive Sample 1.

The aforementioned measurement were conducted respectively by using objective lenses 15 each having different numerical aperture NA (0.45-0.95). Results of the measurement are shown in Table 3 below.

TABLE 3

| | Comparative Sample 1 | Inventive Sample 1 |
|---|---|---|
| NA of | (without coating layer) | (with coating layer) |
| objective lens | % | % |
| 0.45 | 89.2 | 99.9 |
| 0.5 | 89.1 | 99.8 |
| 0.55 | 89.1 | 99.7 |
| 0.6 | 89.0 | 99.5 |
| 0.65 | 88.8 | 99.3 |
| 0.7 | 88.5 | 98.9 |
| 0.75 | 88.1 | 98.4 |
| 0.8 | 87.3 | 97.4 |
| 0.85 | 85.8 | 95.7 |
| 0.9 | 82.8 | 92.3 |
| 0.95 | 74.4 | 83.0 |

As is clear from Table 3, the efficiency of using light in the optical recording medium in Inventive Sample 1 is higher, compared with that in the optical recording medium in Comparative Sample 1. This suggests that better actions of optical recording and reproducing are made to be possible by providing coating layer C.

### EXAMPLE 2

Optical recording media (Inventive Samples 21-28) each having the structure shown in the following Table 4 were prepared.

TABLE 4

| | | | Inventive Sample | | | | | | | |
|---|---|---|---|---|---|---|---|---|---|---|
| | | | 21 | 22 | 23 | 24 | 25 | 26 | 27 | 28 |
| | | | Wavelength for minimum | | | | | | | |
| | | | reflectance (nm) | | | | | | | |
| | | | 410 | 420 | 430 | 440 | 450 | 460 | 470 | 480 |
| | Material | Refractive | — | — | — | — | — | — | — | — |
| | name | index | | | | | | | | |
| | | (λ = 405 nm) | | | | | | | | |
| Medium | Air | 1 | | | | | | | | |
| Third | SiO₂ | 1.47 | 88.7 nm | 90.9 nm | 93.0 nm | 95.2 nm | 97.4 nm | 99.5 nm | 101.7nm | 103.9 nm |
| layer | (Silicon | | | | | | | | | |
| | oxide) | | | | | | | | | |
| Second | Ta₂O₅ | 2.12 | 20.7 nm | 21.2 nm | 21.7 nm | 22.2 nm | 22.7 nm | 23.2 nm | 23.7 nm | 24.2 nm |
| layer | (Tantalum | | | | | | | | | |
| | pentoxide) | | | | | | | | | |
| First | SiO₂ | 1.47 | 16.7 nm | 17.l nm | 17.6 nm | 18.0 nm | 18.4 nm | 18.8 nm | 19.2 nm | 19.6 nm |
| layer | (Silicon | | | | | | | | | |
| | oxide) | | | | | | | | | |
| Base | PC (Poly- | 1.61 | 1.2 mm | 1.2 mm | 1.2 mm | 1.2 mm | 1.2 mm | 1.2 mm | 1.2 mm | 1.2 mm |
| body | carbonate) | | | | | | | | | |
| Meal | Al | — | 500 nm | 500 nm | 500 nm | 500 nm | 500 nm | 500 nm | 500 nm | 500 nm |
| mirror | (Aluminum) | | | | | | | | | |

In Table 4, the column of “Wavelength for minimum reflectance” shows a wavelength of light showing the minimum value of reflectance in coating layer C (First layer-third layer in Table 4). Optical recording media of Inventive Samples 21-28 were prepared by the same preparing method as in the optical recording medium in the Inventive Sample 1.

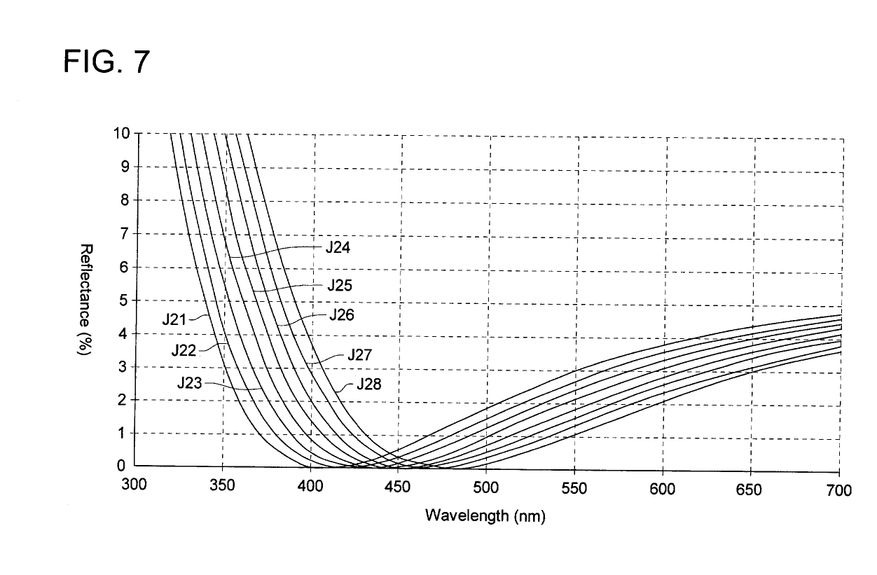

FIG. 7 shows reflectances (J21-J28) on the surface on the coating layer side in optical recording media in Inventive Samples 21-28. Incidentally, in FIG. 7, wavelength-dependence of reflectance at an incident angle of 0° for light is shown.

Measurement of efficiency of using light for optical recording media in Inventive Samples 21-28 was conducted respectively by using objective lenses 15 each having different numerical aperture NA (0.45, 0.60, 0.70, 0.80 and 0.85), in the same way as in the Inventive Sample 1. Results are shown in Table 5 below.

TABLE 5

| | | Inventive Sample | | | | | | | |
|---|---|---|---|---|---|---|---|---|---|
| | | 21 | 22 | 23 | 24 | 25 | 26 | 27 | 28 |
| | | Wavelength for minimum | | | | | | | |
| | | reflectance (nm) | | | | | | | |
| | | 410 | 420 | 430 | 440 | 450 | 460 | 470 | 480 |
| NA of | Efficiency of | 99.93 | 99.90 | 99.67 | 99.22 | 98.55 | 97.66 | 96.55 | 95.23 |
| objective | using light at | | | | | | | | |
| lens | NA = 0.45 | | | | | | | | |
| | NA = 0.60 | 99.66 | 99.79 | 99.74 | 99.48 | 99.02 | 98.35 | 97.45 | 96.35 |
| | NA = 0.70 | 99.10 | 99.38 | 99.49 | 99.42 | 99.16 | 98.69 | 98.00 | 97.11 |
| | NA = 0.80 | 97.68 | 98.15 | 98.48 | 98.66 | 98.66 | 98.47 | 98.08 | 97.49 |
| | NA = 0.85 | 96.01 | 96.60 | 97.08 | 97.43 | 97.62 | 97.64 | 97.46 | 97.08 |

As is clear from Table 5, efficiency of using light shows a value as high as 95% or more in all Inventive Comparative Samples 21-28. In addition, a wavelength for minimum reflectance value in the coating layer is longer than a wavelength (405 nm) of laser diode 11 in all of Inventive Samples 21-28. This implies that it is possible to improve further the efficiency of using light, by providing a coating layer wherein a wavelength of light for the minimum reflectance value is longer than a laser wavelength of laser diode 11, independently of numerical aperture NA of objective lens 15. It is understood that it is possible to prevent efficiently that incident light is reflected and thereby to enhance efficiency of using light, even when conducting recording or reading of information by means of light having a wavelength which is shorter than that of light that takes the minimum value of reflectance of the coating layer, on the contrary.

Further, Table 5 shows that the efficiency of using light can be enhanced sufficiently by coating layer C and a laser beam emitted from laser diode 11 which satisfy the following conditional expressions, when NA represents a numerical aperture of an objective lens, λ₀ represents a laser wavelength of laser diode 11 and λ represents a wavelength of light for the minimum reflectance value in a coating layer;

1.00 λ₀≦λ<1.03 λ₀ (namely, 0.97 λ<λ0≦1.00 λ) for objective lens 15 with NA<0.60,

1.03 λ₀≦λ<1.05 λ₀ (namely, 0.95 λ<λ0≦0.97 λ) for objective lens 15 with 0.60≦NA<0.80, and

1.05 λ₀≦λ<1.50 λ₀ (namely, 0.67 λ<λ0≦0.95 λ) for objective lens 15 with 0.80≦NA.

In particular, it is understood that the efficiency of using light of optical recording medium R in Inventive Sample 21 wherein a wavelength for the minimum reflectance value of coating layer C is 410 nm is the best, when the numerical aperture NA of objective lens 15 is 0.45.

Further, it is understood that the efficiency of using light of the optical recording medium in Inventive Sample 22 wherein a wavelength for the minimum reflectance value of coating layer C is 420 nm is the best, when the numerical aperture NA of objective lens 15 is 0.60.

Further, it is understood that the efficiency of using light of the optical recording medium in Inventive Sample 23 wherein a wavelength for the minimum reflectance value of coating layer C is 430 nm is the best, when the numerical aperture NA of objective lens 15 is 0.70.

Further, it is understood that the efficiency of using light of the optical recording medium in Inventive Sample 24 wherein a wavelength for the minimum reflectance value of coating layer C is 440 nm and of the optical recording medium in Inventive Sample 25 wherein a wavelength for the minimum reflectance value of coating layer C is 450 nm is the best, when the numerical aperture NA of objective lens 15 is 0.80.

In addition, it is understood that the efficiency of using light of the optical recording medium R in Inventive Sample 26 wherein a wavelength for the minimum reflectance value of coating layer C is 460 nm is the best, when the numerical aperture NA of objective lens 15 is 0.85.

The relationship of correspondence between numerical aperture NA of objective lens 15 and the maximum incident angle of light to optical recording medium R is shown in the following Table 6. The following Table 7 below shows incident angles of light that takes the minimum reflectance value when a laser beam with wavelength λ=405 nm is used for each of optical recording media in Inventive Samples 21-28.

TABLE 6

| | Maximum incident |
|---|---|
| NA | angle(°) |
| 0.4 | 23.6 |
| 0.45 | 26.7 |
| 0.5 | 30.0 |
| 0.55 | 33.4 |
| 0.6 | 36.9 |
| 0.65 | 40.5 |
| 0.7 | 44.4 |
| 0.75 | 48.6 |
| 0.8 | 53.1 |
| 0.85 | 58.2 |
| 0.9 | 64.2 |
| 0.95 | 71.8 |

TABLE 7

| | Incident angle (°) |
|---|---|
| Inventive sample 21 | 14.2 |
| Inventive Sample 22 | 22.8 |
| Inventive Sample 23 | 28.4 |
| Inventive Sample 24 | 32.8 |
| Inventive Sample 25 | 36.4 |
| Inventive Sample 26 | 39.6 |
| Inventive Sample 27 | 42.2 |
| Inventive Sample 28 | 44.4 |

As is clear from Tables 6 and 7, it is understood that the higher efficiency of using light is shown on the optical recording medium (optical recording medium in each of Inventive Samples 21 and 22 in the case of NA=0.45) wherein an incident angle of light taking the minimum reflectance value shown in Table 7 is smaller than the maximum incident angle (26.7° in the case of NA=0.45) of the objective lens shown in Table 6, when objective lenses each having the same numerical aperture (for Comparative Sample, NA=0.45) are used.

The foregoing shows that the efficiency of using light can be raised by providing coating layer C wherein the minimum value of reflectance for light entering through the space between the center and the outermost circumference of objective lens 15 is smaller than reflectance for light entering from the center of objective lens 15 and is smaller than reflectance for light entering from the outermost circumference of objective lens 15 (in other words, the maximum value of reflectance for light is great). By making the light from objective lens 15 to pass through the coating layer C on the contrary, efficiency of using light can be improved as shown in FIG. 5, namely, an amount of incident light to information recording surface A1 of optical recording medium R can be made large, because an amount of light that enters from a space between the center and the outermost circumference of the objective lens 15 and passes through the coating layer C and base body B is relatively large, which is understandable.

(Embodiment 2)

Optical recording medium R of the second embodiment is represented by coating layer C in the optical recording medium R of the first embodiment which is structured so that transmittance of light may be smaller when an incident angle is smaller in a range within incident angles of light that enters from the outermost circumference within an effective diameter of optical information recording and reproducing device 10. Namely, the coating layer C is an optical layer of the invention.

In the optical recording medium R in the second embodiment, when conducting recording and reading of information by optical information recording and reproducing device 10, it is more difficult for a laser beam to be transmitted through coating layer C when the laser beam enters at a smaller incident angle. Due to this, it is possible to reduce an amount of light entering at a smaller incident angle, and to make an optical spot diameter to be small by a super-resolution effect, thus, high density recording can be realized, and efficiency of reading and recording of optical information can be improved.

Further, it is possible to realize a small optical spot diameter without providing a filter on the optical information recording and reproducing device 10 side, which is different from the past. In addition, high density recording can be realized while keeping the cost for the optical information recording and reproducing device 10 to be low, because a small optical spot diameter can be realized without using a laser beam having a short wavelength and objective lens 15 with high NA.

Incidentally, in the optical recording medium R of the second embodiment, coating layer C is structured so that transmittance for light may be smaller when an incident angle is smaller in a range within incident angles of light that enters from the outermost circumference within an effective diameter of optical information recording and reproducing device 10. However, it is also possible to reduce an amount of light entering at a small incident angle and thereby to obtain a super-resolution effect without being limited to the aforesaid structure, provided that the coating layer has the structure wherein the smaller is the incident angle in a range within optional incident angles of light, the smaller is the transmittance.

It is also possible to structure the coating layer C so that transmittance of the wavelength area preceding a prescribed wavelength area for light may be smaller than that of the wavelength area following the prescribed wavelength area. In this case, it is possible to make an optical spot diameter to be small and to realize high density recording, as in the foregoing.

### EXAMPLE 3

The optical recording media (corresponding to optical recording medium R in the second embodiment) of Inventive Samples 31-33 each having the structure shown in Table 8 below.

TABLE 8

| | | Refrac- | | | |
|---|---|---|---|---|---|
| | | tive | | | |
| | | index | | | |
| | | (λ = | Inventive | Inventive | Inventive |
| | Material name | 405 nm) | Sample 31 | Sample 32 | Sample 33 |
| Medium | Air | 1 | — | — | — |
| 31st | SiO₂ | 1.47 | — | — | 28.21 nm |
| layer | (Silicon oxide) | | | | |
| 30th | TiO₂ | 2.46 | — | — | 66.97 nm |
| layer | (Titanium oxide) | | | | |
| 29th | SiO₂ | 1.47 | — | — | 87.97 nm |
| layer | (Silicon oxide) | | | | |
| 28th | TiO₂ | 2.46 | — | — | 68.85 nm |
| layer | (Titanium oxide) | | | | |
| 27th | SiO₂ | 1.47 | — | — | 86.13 nm |
| layer | (Silicon oxide) | | | | |
| 26th | TiO₂ | 2.46 | — | — | 50.98 nm |
| layer | (Titanium oxide) | | | | |
| 25th | SiO₂ | 1.47 | — | — | 31.96 nm |
| layer | (Silicon oxide) | | | | |
| 24th | TiO₂ | 2.46 | — | — | 1.56 nm |
| layer | (Titanium oxide) | | | | |
| 23rd | SiO₂ | 1.47 | — | — | 88.47 nm |
| layer | (Silicon oxide) | | | | |
| 22nd | TiO₂ | 2.46 | — | 28.96 nm | |
| layer | (Titanium oxide) | | | | |
| 21st | SiO₂ | 1.47 | — | — | 32.92 nm |
| layer | (Silicon oxide) | | | | |
| 20th | TiO₂ | 2.46 | — | — | 18.74 nm |
| layer | (Titanium oxide) | | | | |
| 19th | SiO₂ | 1.47 | — | — | 58.92 nm |
| layer | (Silicon oxide) | | | | |
| 18th | TiO₂ | 2.46 | — | 33.05 nm | 7.76 nm |
| layer | (Titanium oxide) | | | | |
| 17th | SiO₂ | 1.47 | — | 71.56 nm | 5.87 nm |
| layer | (Silicon oxide) | | | | |
| 16th | TiO₂ | 2.46 | — | 64.9 nm | 33.4 nm |
| layer | (Titanium oxide) | | | | |
| 15th | SiO₂ | 1.47 | — | 73.47 nm | 20.35 nm |
| layer | (Silicon oxide) | | | | |
| 14th | TiO₂ | 2.46 | 46.69 nm | 71.65 nm | 22.84 nm |
| layer | (Titanium oxide) | | | | |
| 13th | SiO₂ | 1.47 | 74.06 nm | 78.48 nm | 5.55 nm |
| layer | (Silicon oxide) | | | | |
| 12th | TiO₂ | 2.46 | 12.37 nm | 35.55 nm | 73.07 nm |
| layer | (Titanium oxide) | | | | |
| 11th | SiO₂ | 1.47 | 81.75 nm | 37.12 nm | 19.67 nm |
| layer | (Silicon oxide) | | | | |
| 10th | TiO₂ | 2.46 | 48.78 nm | 2.86 nm | 21.57 nm |
| layer | (Titanium oxide) | | | | |
| 9th | SiO₂ | 1.47 | 81.08 nm | 44.04 nm | 9.9 nm |
| layer | (Silicon oxide) | | | | |
| 8th | TiO₂ | 2.46 | 49.93 nm | 30.18 nm | 50.93 nm |
| layer | (Titanium oxide) | | | | |
| 7th | SiO₂ | 1.47 | 86.17 nm | 41.65 nm | 2.26 nm |
| layer | (Silicon oxide) | | | | |
| 6th | TiO₂ | 2.46 | 46.8 nm | 38.01 nm | 34.83 nm |
| layer | (Titanium oxide) | | | | |
| 5th | SiO₂ | 1.47 | 45.51 nm | 24.21 nm | 32.5 nm |
| layer | (Silicon oxide) | | | | |
| 4th | TiC₂ | 2.46 | 39.62 nm | 46.3 nm | 14.48 nm |
| layer | (Titanium oxide) | | | | |
| 3rd | SiO₂ | 1.47 | 24.14 nm | 40.73 nm | 46.24 nm |
| layer | (Silicon oxide) | | | | |
| 2nd | TiC₂ | 2.46 | 44.96 nm | 28.17 nm | 3.54 nm |
| layer | (Titanium oxide) | | | | |
| 1st | SiO₂ | 1.47 | 31.85 nm | 4.62 nm | 41.19 nm |
| layer | (Silicon oxide) | | | | |
| Base | PC | 1.61 | 1.2 mm | 1.2 mm | 1.2 mm |
| body | (Polycarbonate) | | | | |
| Metal | AL (Aluminum) | — | 500 nm | 500 nm | 500 nm |
| mirror | | | | | |

In preparation of optical recording media in Inventive Samples 31-33, an aluminum metal mirror was coated on one side of each base body through a vacuum deposition method, in the same way as in Comparative Sample 1, and each of coating layers (first layer-31^{st} layer) was coated on the other side of the base body through a vacuum deposition method. In the deposition of coating layers, a temperature to heat the base body was made to be 80° C., and there were used the pressure of oxygen gas of 1.0×10⁻² Pa (for deposition of silicon oxide), the pressure of 1.5×10⁻² Pa (for deposition of titanium oxide), deposition speed of 2.0 nm/sec for silicon oxide and that of 0.5 nm/sec for titanium oxide.

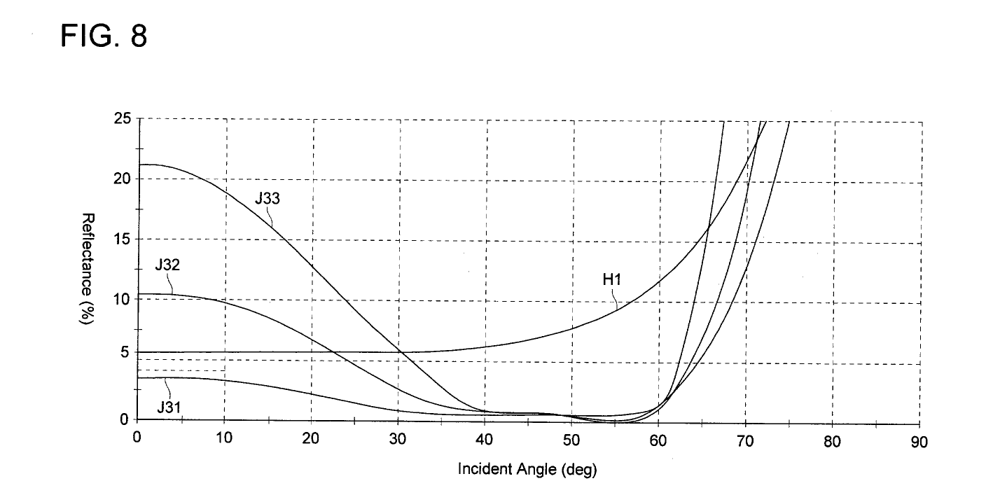

FIG. 8 shows respectively reflectances (J31-J33) each representing the reflectance on the surface closer to the coating layer on each of the optical recording media of Inventive Samples 31-33 and reflectance (H1) on the surface of the optical recording medium on the base body side in Comparative Sample 1. Incidentally, in FIG. 8, there is shown wavelength-dependence of reflectance for the light having wavelength 405 nm.

In the same way as in the aforementioned Comparative Sample 1, efficiency of using light for each of the optical recording media in Inventive Samples 31-33 was measured by the use of objective lens 15 having numeral aperture NA of 0.85. Further, a spot diameter of a laser beam was measured for each of the optical recording media in Inventive Samples 31-33. Results thereof are shown in Table 9 below.

TABLE 9

| | Comparative | Inventive | Inventive | Inventive |
|---|---|---|---|---|
| | Sample 1 | Sample 31 | Sample 32 | Sample 33 |
| Efficiency | 85.8 | 97.48 | 96.49 | 94.42 |
| of using | | | | |
| light (%) | | | | |
| Size of | 0.39 | 0.33 | 0.28 | 0.23 |
| spot | | | | |
| diameter | | | | |
| (μm) | | | | |

Now, the Table 6 stated above indicates that the maximum incident angle of objective lens 15 having NA=0.85 is 58.2°. FIG. 8 shows that reflectance of the optical recording medium in each of Inventive Samples 31-33 for a ray of light entering at the maximum incident angle (58.2°) of objective lens 15 is smaller than that of the optical recording medium in Comparative Sample 1 for the ray of light, namely, transmittance for a ray of light that enters at the maximum incident angle and passes through coating layer C and base body B of the optical recording medium in each of Inventive Samples 31-33 is greater than that for a ray of light passing through the base body in Comparative Sample 1. Further, FIG. 8 shows that the reflectance of each of the optical recording media in Inventive Samples 31-33 is greater when the incident angle is smaller (in other words, the smaller the incident angle is, the smaller the transmittance is), although the reflectance of the recording medium in Comparative Sample 1 is almost constant in a range within the maximum incident angle for objective lens 15.

As is clear from Table 9, in the optical recording medium in each of Inventive Samples 31-33, it is possible to enhance the efficiency of using light, namely, to make an amount of transmitted light to be great, compared with the optical recording medium in Comparative Sample 1, by making light to enter, in particular, by making light including a ray of light entering an information recording surface at the maximum incident angle to enter. It was further found that the spot diameter is smaller in Inventive Samples 31-33 and a super-resolution effect can be obtained, compared with Comparative Sample 1.

In the past, a decline of efficiency of using light was unavoidable, because a filter to reflect light or a filter to absorb light was used to obtain a super-resolution effect. In the optical recording medium in the second embodiment of the invention, on the contrary, efficiency of using light can be raised, and a super-resolution effect can be obtained. Further, the invention makes it possible to realize higher density recording even when an objective lens having the same numerical aperture is used.

(Embodiment 3)

Optical recording medium R of the third embodiment is represented by coating layer C in the optical recording medium R of the first embodiment which is structured so that transmittance of light may be smaller when an incident angle is greater in a range within incident angles of light that enters from the outermost circumference within an effective diameter of optical information recording and reproducing device 10.

In the optical recording medium R in the third embodiment, when conducting recording and reading of information by optical information recording and reproducing device 10, it is more difficult for a laser beam to be transmitted through coating layer C when the laser beam enters at a greater incident angle. Due to this, a side-lobe of an optical spot can be reduced by an apodization effect, and therefore, it is possible to improve efficiency of reading and recording of optical information, by preventing erroneous operations in reading and recording of information by optical information recording and reproducing device 10.

Further, it is possible to reduce side-lobes without providing a filter on the optical information recording and reproducing device 10 side, which makes it possible to attain cost reduction for the optical information recording and reproducing device 10.

Incidentally, in the optical recording medium R of the third embodiment, coating layer C can also be structured so that transmittance for light in a wavelength area following the prescribed wavelength area may be greater than that of a wavelength area preceding the prescribed wavelength area. In this case, it is difficult for the light entering at a greater incident angle to be transmitted coating layer C, and thereby, side-lobes can be reduced in the same way as in the foregoing, and erroneous operations of the optical information recording and reproducing device 10 can be prevented.

### EXAMPLE 4

The optical recording media (each corresponding to optical recording medium R in the third embodiment) of Inventive Samples 41 and 42 each having the structure shown in Table 10 below were prepared.

TABLE 10

| | | Refractive | | |
|---|---|---|---|---|
| | | index | Inventive | Inventive |
| | Material name | (λ = 405 nm) | Sample 41 | Sample 42 |
| Medium | Air | 1 | — | — |
| 5th | SiO₂ | 1.47 | — | 145.29 nm |
| layer | (Silicon oxide) | | | |
| 4th | TiO₂ | 2.46 | — | 82.75 nm |
| layer | (Titanium oxide) | | | |
| 3rd | SiO₂ | 1.47 | 36.6 nm | 43.09 nm |
| layer | (Silicon oxide) | | | |
| 2nd | TiO₂ | 2.46 | 73.29 nm | 74.87 nm |
| layer | (Titanium oxide) | | | |
| 1st | Si0₂ | 1.47 | 219.65 nm | 14.38 nm |
| layer | (Silicon oxide) | | | |
| Base | PC | 1.61 | 1.2 mm | 1.2 mm |
| body | (Polycarbonate) | | | |
| Metal | AL (Aluminum) | — | 500 nm | 500 nm |
| mirror | | | | |

The optical recording media of Inventive Samples 41 and 42 were prepared in the same preparation method as in the optical recording media of the aforementioned Inventive Samples 31-33.

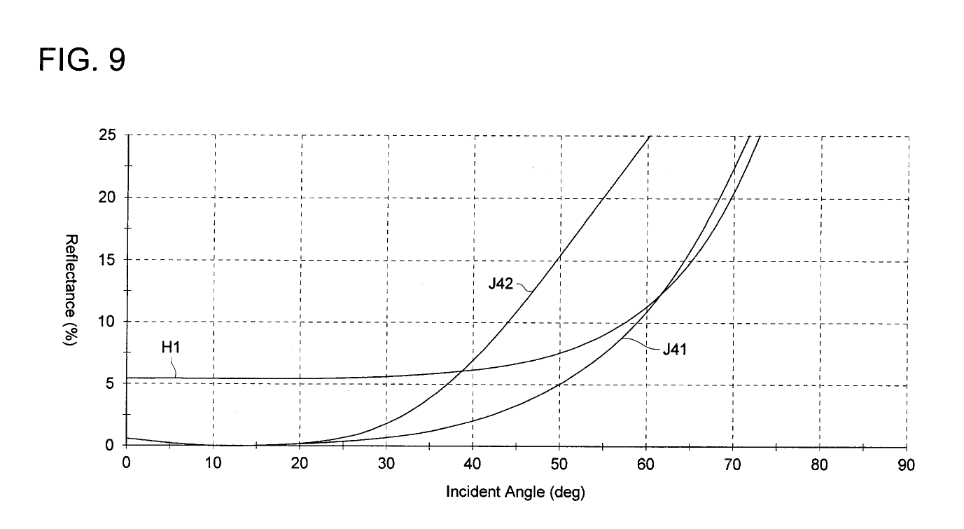

FIG. 9 shows respectively reflectances (J41 and J42) each representing the reflectance on the surface closer to the coating layer on each of the optical recording media of Inventive Samples 41 and 42 and reflectance (H1) on the surface of the optical recording medium on the base body side in Comparative Sample 1. Incidentally, in FIG. 9, there is shown wavelength-dependence of reflectance for the light having wavelength 405 nm.

In the same way as in the aforementioned Inventive Sample 1, efficiency of using light for each of the optical recording media in Inventive Samples 41 and 42 was measured by the use of objective lens 15 having numeral aperture NA of 0.85. Further, a spot diameter of a laser beam was measured for each of the optical recording media in Inventive Samples 41 and 42. Results thereof are shown in Table 11 below.

TABLE 11

| | Comparative | Inventive | Inventive |
|---|---|---|---|
| | Sample | Sample 41 | Sample 42 |
| Efficiency of using | 85.8 | 91.5 | 76.49 |
| light (%) | | | |
| Size of spot | 0.39 | 0.41 | 0.45 |
| diameter (μm) | | | |

Now, the Table 6 stated above indicates that the maximum incident angle of objective lens 15 having NA=0.85 is 58.2°. FIG. 9 shows that the reflectance of each of the optical recording media in Inventive Samples 41-42 is greater when the incident angle is greater, for the incident angle of 30° or more (in other words, the greater the incident angle is, the smaller the transmittance is), although the reflectance of the recording medium in Comparative Sample 1 is almost constant in a range within the maximum incident angle (58.2°) for objective lens 15. It is further understood that reflectance of the optical recording medium in Inventive Sample 41 for light entering at the maximum incident angle of objective lens is smaller than that of the optical recording medium in Comparative Sample 1 for the aforementioned light. In other word, it is understood that transmittance of a ray of light that enters at the maximum incident angle and passes through coating layer C and base body B of the optical recording medium in Inventive Sample 41 is greater than that for light passing through the base body in Comparative Sample 1.

As is clear from Table 11, it is possible to raise the efficiency of using light more in the optical recording medium in Inventive Sample 41 by making light to enter, in particular, by making light including a ray of light entering the information recording surface at the maximum incident angle, compared with the optical recording medium in Comparative Sample 1.

Though an optical spot diameter is large in each of the optical recording media of Inventive Samples 41 and 42, compared with the optical recording medium in Comparative Sample 1, it is understood, from the reflectance characteristics shown in FIG. 9, that side-lobes of a laser beam can be reduced by the apodization effect. In particular, in the optical recording medium of Inventive Sample 41, efficiency of using light can be raised and side-lobes can be reduced.

In the Structure (1), it is possible to prevent that the incident light is reflected when conducting reading and recording of optical information, and thereby to enhance the efficiency of using light. Accordingly, it is possible to conduct reading and recording of optical information satisfactorily, and to further improve efficiency of reading and recording of information.

In the Structure (2), it is possible to prevent surely that light is reflected on the uppermost portion of the surface on the side where light enters, when conducting reading or recording of information.

In the Structure (3), it is possible to prevent efficiently that incident light is reflected, by using the antireflection layer that shows the minimum value of reflectance for light having longer wavelength than light entering for conducting reading and recording of information.

In the Structures (4)-(6), it is possible to prevent effectively that an incident light is reflected, and to improve the efficiency of using light accordingly.

In the Structure (7), it is possible to make the total amount of light passing through an antireflection layer to be large, namely, to enhance the efficiency of using light, by making the light passing through a space between the center and the outermost circumference of the objective lens to enter the antireflection layer, when conducting reading or recording of information.

In the Structure (8), the total amount of light entering the information recording surface can be made large, namely, the efficiency of using light can be enhanced, compared with an occasion where no antireflection layer is provided.

In the Structure (9), it is possible to make an amount of light entering the information recording surface of the optical recording medium to be large, namely, to enhance the efficiency of using light, by making light including a ray of light of the maximum incident angle to enter the antireflection layer.

In the Structure (10), an amount of light entering at a small incident angle can be reduced in the same way as in the conventional occasion wherein the center of a light flux is shielded by a filter, because the light having the smaller incident angle is more hardly transmitted through the optical layer. It is therefore possible to make an optical spot diameter to be small by a super-resolution effect without increasing the number of parts of an optical information recording and reproducing device and thereby to improve efficiency of reading and recording of optical information by realizing high density recording.

In the Structure (11), an amount of light entering at a large incident angle can be reduced in the same way as in the conventional occasion wherein the outer ring-shaped portion of a light flux is shielded by a filter, because the light having the greater incident angle is more hardly transmitted through the optical layer. It is therefore possible to reduce side-lobes of an optical spot by an apodization effect without increasing the number of parts of an optical information recording and reproducing device, and thereby to improve efficiency of reading and recording of information by preventing erroneous operations for reading and recording of optical information.

In the Structure (12), it is possible to obtain the same effect as in the Structure (10) in the case that “the transmittance for light of the wavelength area preceding a prescribed wavelength area is smaller than that of the wavelength area that follows the prescribed wavelength area”, And it is possible to obtain the same effect as in the Structure (11) in the case that “the transmittance for light of the wavelength area following a prescribed wavelength area is smaller than that of the wavelength area that precedes the prescribed wavelength area”.

In the Structure (13), an amount of incident light on the optical layer can be controlled surely on the surface of the optical recording medium, when conducting reading or recording of information.

In the Structure (14), recording and reading of information by means of light can be conducted more satisfactorily, and power of recording and reading of information can be further improved.

In the Structure (15), it is possible to prevent surely that light is reflected on the surface of the optical recording medium.

In the Structure (16), it is possible to prevent effectively that incident light is reflected, and to enhance the efficiency of using light.

In the Structures (17)-(19), it is possible to prevent effectively that incident light is reflected, and thereby to enhance the efficiency of using light.

In the Structure (20), it is possible to make the total amount of light at the antireflection layer in the course of recording or reading of information to be large, namely, to enhance the efficiency of using light.

In the Structure (21), the total amount of light entering the information recording surface can be made large, namely, the efficiency of using light can be enhanced, compared with an occasion where no antireflection layer is provided.

In the Structure (22), the total amount of light entering the information recording surface can be made large, namely, the efficiency of using light can be enhanced, compared with an occasion where no antireflection layer is provided.

In the Structure (23), an amount of light entering at a small incident angle can be reduced, and an optical spot diameter can be made small by a super-resolution effect, in the same way as in the conventional occasion wherein the center of a light flux is shielded by a filter. Therefore, it is possible to realize high density recording and to improve efficiency of reading or recording of information by means of light without making a wavelength of a laser to be shorter, without making NA of an objective lens to be higher, and without increasing the number of parts of an optical information recording and reproducing device.

In the Structure (24), an amount of light entering at a large angle can be reduced, and a side-lobe of a light spot is reduced by an apodization effect in the same way as in the conventional occasion wherein an outer ring-shaped zone portion of a light flux is shielded by a filter. It is therefore possible to improve efficiency of recording and reading of information by preventing erroneous operations for recording and reading of information by means of light, without increasing the number of parts of an optical information recording and reproducing device.

In the Structure (25), when “transmittance for light in the wavelength area preceding the prescribed wavelength is smaller than that for light in the wavelength area succeeding the prescribed wavelength”, the same effect as in the Structure (23) can be obtained, and when “transmittance for light in the wavelength area succeeding the prescribed wavelength is smaller than that for light in the wavelength area preceding the prescribed wavelength”, the same effect as in the Structure (24) can be obtained.

In the Structure (26), the control of an amount of incident light transmitted through the optical layer can be conducted surely on the surface of the optical recording medium.

What is claimed is:

1. An optical recording medium for conducting at least one of reading and recording of optical information, the optical recording medium comprising:
(a) a base board; and
(b) an antireflection layer composed of at least one layer, being provided on a surface of a side of the base board where light enters for conducting at least one of the reading and recording of information,
wherein a wavelength of light that makes reflectance of the antireflection layer to light to be smallest is longer than that of the light that enters for conducting at least one of the reading and recording of information.

2. The optical recording medium of claim 1, wherein at least one of the reading and recording of information is conducted by light that is converged by an objective lens with a numerical aperture smaller than 0.60, and the following condition is satisfied;
1.00 λ₀≦λ<1.03 λ₀,
wherein λ₀ represents a wavelength of light that enters for conducting at least one of the reading and recording of information, and λ represents a wavelength of light that makes reflectance of the antireflection layer to be minimum.

3. The optical recording medium of claim 1, wherein at least one of the reading and recording of information is conducted by light that is converged by an objective lens whose numerical aperture is not less than 0.60 and is smaller than 0.80, and the following condition is satisfied;
1.03 λ₀≦λ<1.05 λ₀,
wherein λ₀ represents a wavelength of light that enters for conducting at least one of the reading and recording of information, and λ represents a wavelength of light that makes reflectance of the antireflection layer to be minimum.

4. The optical recording medium of claim 1, wherein at least one of the reading and recording of information is conducted by light that is converged by an objective lens whose numerical aperture is not less than 0.80, and the following condition is satisfied;
1.05 λ₀≦λ≦1.50 λ₀,
wherein λ₀ represents a wavelength of light that enters for conducting at least one of the reading and recording of information, and λ represents a wavelength of light that makes reflectance of the antireflection layer to be minimum.

5. The optical recording medium of claim 1, wherein at least one of the reading and recording of information is conducted by light that is converged by an objective lens, and a maximum value of transmittance of the antireflection layer for light that enters after passing a space between a center of the objective lens and an outermost circumference within an effective diameter of the objective lens is greater than transmittance of the antireflection layer for light that enters after passing the center of the objective lens and is greater than transmittance of the antireflection layer for light that enters after passing the outermost circumference of the objective lens.

6. The optical recording medium of claim 1,
wherein the base board is a transparent base board provided between the antireflection layer and an information recording surface which is provided to be closer to a rear surface side than the antireflection layer and is to be recorded with information or has been recorded with information, and
wherein a total amount of plural rays of light entering the antireflection layer at various incident angles, then passing through the antireflection layer and the transparent base board, and entering the information recording surface is greater than a total amount of plural rays of light which enter the transparent base board at various incident angles when the antireflection layer is not provided and pass through the transparent base board to enter the information recording surface.

7. The optical recording medium of claim 1,
wherein the base board is a transparent base board provided between the antireflection layer and an information recording surface which is provided to be closer to a rear surface side than the antireflection layer and is to be recorded with information or has been recorded with information, and
wherein transmittance for light entering the antireflection layer at a maximum incident angle, then passing through the antireflection layer and the transparent base board, and entering the information recording surface is greater than that of light which enters the transparent base board at the maximum incident angle when the antireflection layer is not provided and passes through the transparent base board to enter the information recording surface.

8. An optical recording medium conducting at least one of reading and recording of information by means of light, comprising:
(a) a base board; and
(b) an optical layer provided on a side of the base board where light enters for conducting at least one of reading and recording of information, the optical layer composed of at least one layer having smaller transmittance for light when an incident angle is smaller within a range of a prescribed incident angle for light.

9. An optical recording medium conducting at least one of reading and recording of information by means of light, comprising:
(a) a base board; and
(b) an optical layer provided on a side of the base board where light enters for conducting at least one of the reading and recording of information, the optical layer composed of at least one layer having smaller transmittance for light when an incident angle is greater within a range of a prescribed incident angle for light.

10. An optical recording medium conducting at least one of reading and recording of information by means of light, comprising:
(a) a base board; and
(b) an optical layer provided on a side of the base board where light enters for conducting at least one of the reading and recording of information, the optical layer composed of at least one layer and having different transmittances on both sides of a boundary of a prescribed wavelength.

11. The optical recording medium of claim 8, wherein the optical layer is provided on a surface of the side where light enters for conducting at least one of reading and recording of information.

12. The optical recording medium of claim 9, wherein the optical layer is provided on a surface of the side where light enters for conducting at least one of reading and recording of information.

13. The optical recording medium of claim 10, wherein the optical layer is provided on a surface of the side where light enters for conducting at least one of reading and recording of information.

14. A method of recording and reading of information, comprising the steps of:
(a) converging light with an objective lens; and
(b) making the converged light to pass through an antireflection layer first composed of at least one layer provided an optical recording medium; and
(c) conducting at least one of recording and reading of information by light having a wavelength shorter than a wavelength of light which makes reflectance of the antireflection layer for light to be minimum.

15. The method of claim 14, wherein the numerical aperture of the objective lens is smaller than 0.60, and at least one of the recording and reading of information is conducted by light satisfying the following condition;
0.97λ<λ0≦1.00λ,
wherein λ0 represents a wavelength of light that enters for conducting at least one of the recording and reading of information, and λ represents a wavelength of light that makes reflectance of the antireflection layer to be minimum.

16. The method of claim 14, wherein the numerical aperture of the objective lens is not less than 0.60 and is smaller than 0.8, and at least one of the recording and reading of information is conducted by means of light satisfying the following condition;
0.95 λ<λ0≦0.97 λ,
wherein λ0 represents a wavelength of light that enters for conducting at least one of the recording and reading of information, and λ represents a wavelength of light that makes reflectance of the antireflection layer to be minimum.

17. The method of claim 14, wherein the numerical aperture of the objective lens is not less than 0.80, and at least one of the recording and reading of information is conducted by means of light satisfying the following condition;
0.67 λ<λ0≦0.95 λ,
wherein, λ0 represents a wavelength of light that enters for conducting at least one of the recording and reading of information, and λ represents a wavelength of light that makes reflectance of the antireflection layer to be minimum.

18. The method of claim 14, wherein a maximum value of transmittance of the antireflection layer for light that enters after passing a space between a center of the objective lens and an outermost circumference within an effective diameter of the objective lens is greater than transmittance of the antireflection layer for light that enters after passing the center of the objective lens and is greater than transmittance of the antireflection layer for light that enters after passing the outermost circumference of the objective lens.

19. The method of claim 14, wherein a transparent base board is provided on the optical recording medium between the antireflection layer and the information recording surface that is provided to be closer to the rear side than the antireflection layer and is recorded or has been recorded with information, and a total amount of plural rays of light entering the antireflection layer at various incident angles, then passing through the antireflection layer and the transparent base board, and entering the information recording surface is greater than a total amount of plural rays of light which enter the transparent base board at various incident angles when the antireflection layer is not provided and pass through the transparent base board to enter the information recording surface, thus at least one of recording and reading of information is conducted by making plural rays of light enter the antireflection layer at various incident angles.

20. The method of claim 14, wherein a transparent base board is provided on the optical recording medium between the antireflection layer and the information recording surface that is provided to be closer to the rear side than the antireflection layer and is recorded or has been recorded with information, and transmittance for the light that enters the antireflection layer at a maximum incident angle and passes through the antireflection layer and the transparent base board to enter the information recording surface is greater than transmittance for the light that enters the transparent base board at the maximum incident angle when the antireflection layer is not provided and passes through the transparent base board to enter the information recording surface, thus a plurality of rays of light including light having the maximum incident angle are made to enter the antireflection layer, and at least one of recording and reading of information is conducted.

21. A method of recording and reading of information, comprising the step of:
(a) converging light with an objective lens; and
(b) making the converged light to pass through an optical layer composed of at least one or more layers provided on an optical recording medium so that transmittance for the light may be smaller when an incident angle for the light is smaller within a range of a prescribed incident angle, thereby conducting at least one of the recording and reading of information for the optical recording medium.

22. A method of recording and reading of information, comprising the step of:
(a) converging light with an objective lens; and
(b) making the converged light to pass through an optical layer composed of at least one or more layers provided on an optical recording medium so that transmittance for the light may be smaller when an incident angle for the light is greater within a range of a prescribed incident angle, thereby conducting at least one of the recording and reading of information for the optical recording medium.

23. A method of recording and reading of information, the method comprising the step of:
(a) converging light with an objective lens; and
(b) making the converged light to pass through an optical layer composed of at least one or more layers provided on an optical recording medium so that transmittances for the light may be different each other on both sides of a boundary of a prescribed wavelength, thereby conducting at least one of recording and reading of information for the optical recording medium.

24. The method of claim 21, wherein the making step includes making the light converged by the objective lens to pass through the optical layer first in the optical recording medium.

25. The method of claim 22, wherein the making step includes making the light converged by the objective lens to pass through the optical layer first in the optical recording medium.

26. The method of claim 23, wherein the making step includes making the light converged by the objective lens to pass through the optical layer first in the optical recording medium.
